(19) United States
(12) Patent Application Publication
(10) Pub. No.: US 2006/0287914 A1
(43) Pub. Date: Dec. 21, 2006

(54) Systems and methods for managing premiums

(76) Inventor: Kevin J. Shelley, New York, NY (US)

Correspondence Address: KIRTON AND MCCONKIE, 60 EAST SOUTH TEMPLE,, SUITE 1800, SALT LAKE CITY, UT, 84111, US

(21) Appl. No.: 11/158,949

(22) Filed: Jun. 21, 2005

(51) Int. Cl. G06Q 30/00

(52) U.S. Cl. 705/14

(57) ABSTRACT

Systems and methods for managing premiums via a central management hub that interacts with multiple types of users. The rewards underlying the premiums may include travel, services, merchandise, or cash discounts. The premiums of the present invention have multiple expanded options.

### BACKGROUND

1. Field of the Invention

The present invention relates generally to systems and methods for centrally managing premiums amongst multiple entities and users. More particularly, the present invention relates to systems and methods for building, securing, offering, and fulfilling unique and flexible premiums in a centralized computer-based environment.

2. Background Information

Often, in order to promote its business or services, a business will offer a bonus to its customers, employees, or others—whether that bonus is tangible physical merchandise such as a clock give-away, or whether that bonus is an intangible service such as a complimentary airfare or hotel stay. For example, a photography studio may offer free airfare and hotel accommodations for a Hawaiian vacation to a customer who buys a particular portrait package.

Such promotions can be extremely valuable to businesses. Research has shown that most consumers are willing to pay full price or higher for a business's product or service in order to receive a desired promotional bonus—and particularly when that bonus is a service or travel give-away. Indeed, surveys show that most consumers perceive gifts as more valuable than their cash equivalents. However, implementing these promotions typically involves unwieldy and complex processes that require the business to involve and coordinate numerous independent entities. The cost per gift item plus the complex nature of implementing these promotions make it difficult to ensure that the promotional campaign is profitable for its sponsor.

For example, a business that sponsors a promotion, such as the photography studio in the example above, typically must take multiple steps to coordinate and fulfill that promotion. First, the sponsoring business must come up with an idea for a type of universally appealing give-away that might bolster that sponsor's business. The sponsor then searches for suppliers of these give-aways from whom the sponsor could purchase the give-aways. Once the sponsor chooses a give-away, the sponsor typically attempts to negotiate bulk discounts with suppliers in order to keep the cost as low as possible for the sponsor. The sponsor also sometimes makes arrangements for the give-aways to be customized with the sponsor's branding. Then, the sponsor arranges for a place to store the give-aways—whether the items to be stored are paper-based certificates/vouchers that represent the give-aways, or whether the items to be stored are the physical merchandise itself. Often, the sponsor also coordinates an advertising campaign to advertise the promotion as well. Moreover, some sponsors implement a simultaneous internal incentive program to motivate higher sales force performance, thus doubling the complexity for the sponsor—especially since these internal programs often require different people (for example, human resources versus marketing), systems, and cultural nuances to set up and operate.

In addition to all this, the sponsor also typically needs to coordinate the “fulfillment” process—that is, the logistics of delivering the promised give-aways and dealing with the associated issues relating to sizes, colors, disappointments, defects, unused inventory, shipping, and returns. Moreover, the sponsor also needs to make sure that the increased business resulting from the promotional campaign is enough to offset the costs of the promotion. Since implementing the promotion requires multiple steps, multiple entities, and multiple legal considerations, monitoring the interrelated parts and the associated costs is difficult to do. And sponsors are loathe to hire specialists to monitor these issues, because hiring additional help only increases the sponsor's costs in what are typically low-margin circumstances. Nevertheless, because of the complexities involved at each step, it is not uncommon for sponsors to outsource various aspects of the promotional campaign rather than spread themselves too thin.

In the case where the give-aways comprise services such as travel, sponsors must manage or outsource even more complex processes. For example, sponsors traditionally search for suppliers who specialize in promotional travel (the promotional travel bargains being commonly known in the industry as “travel premiums”)—since the typical travel agency lacks the skills, relationships, resources, and know-how to provide premium packages that are good for one thousand, ten thousand, or one million people. Once the sponsor narrows down the specialty services needed, then even among these numerous specialty packagers, choosing one over another is difficult. Criteria that a sponsor might use in choosing a packager may include things like location, customer satisfaction track records, national versus regional experience, language capabilities, travel specialty (that is, specialization in cruises, tours, airfare, etc.), integration of design, scalable fulfillment, insurance services, industry certification, state licensing, and more.

After researching and making these decisions, sponsors may then begin to choose from a supplier's pre-existing packages, or with the supplier's guidance may design and personalize their own travel package based on their own wish list—such as a package that offers certain destinations, activities, pricing, and agreeable end-user travel terms and conditions. Either way, these suppliers have relationships and deals in place that may not cover the needed volumes, requirements, or combinations desired by a particular sponsor, and so the supplier may need to establish and negotiate new relationships and deals with that sponsor. Often these new deals are based on pre-determined quantities with tiered pricing (bulk discounts) that have been negotiated with the original vendors (such as hotels, airlines, and cruise lines) or through consolidators or resellers who aggregate and sell even better deals and discounts than the original vendors.

Once the supplier and package is chosen and the sponsor submits a purchase order for an allotment of premiums from the supplier, the supplier typically sends to the sponsor a shipment of paper certificates or vouchers representing redeemable travel premiums—each certificate granting a recipient or end user privileged access to a specific deal, through specific channels, and based on certain conditions. However, in some cases, a sponsor chooses to write, design, and print his own material, the supplier simply approving the final design and print quantity. The sponsor also often advertises its promotion to a designated and often previously agreed-upon audience whom the sponsor wants to target, such as the sponsor's patrons, employees, or executives (for example, “Buy our Elite portrait package by April 30th at regular price, and receive a free airline ticket good on any major airlines . . . call for more details”). The sponsor then issues a certificate to each person who responds and qualifies. A bearer or end user of the certificate who wishes to redeem it for travel will typically fill out a card or paper included with the certificate and mail it to a place indicated thereon.

Someone then contacts the certificate holder to complete the travel booking. The person who contacts the certificate holder is typically a pre-qualified professional travel agent in a travel agency hired by the supplier, as part of the package, to deal with the complexities of travel consulting and booking. However, the supplier usually must do more than simply hire a travel agency. The supplier must also train the agents and/or provide them with scripts, so that the agents understand the specific promotion, its rules and restrictions (for example, blackout dates and usages limited to a specific subset of airlines or hotels), and understand whether and in what manner the agents need to act as temporary representatives of the sponsor.

It is well known in the industry that the profitability of most travel premiums presently relies heavily on “breakage.” Breakage results from the failure of end users to redeem their premiums. For example, an end user might fail to redeem his or her premium due to forgetfulness, loss of his or her certificate, the inability to travel during non-blackout dates, failure to submit required information, etc. It is not uncommon for a particular premium incentive to have ninety percent breakage (that is, ten percent fulfillment), even for exceptional incentives.

Two positive results ensue from the industry's reliance on breakage: (1) all who do complete the redemption process receive great travel savings, and (2) the cost of fulfillment exposed to the supplier, and the associated cost of the premium to the sponsor remain low. On the other hand, negative results also ensue from the reliance on breakage. Since breakage reduces costs for vendors/resellers/sponsors, these benefactors are motivated to do all they can to discourage end user redemption and thereby increase breakage percentages to maximize these benefactors' profit. This is done, for example, by attaching a gauntlet of terms and conditions to the travel premiums. Some common terms and conditions include blackout dates, hidden fees passed on to the end user, short expiration dates, required submissions of multiple paperwork, and delays in processing.

Unfortunately, the reliance on breakage has undermined public trust in the value of travel premiums. Indeed, travel premiums and their promoters have become notorious for their lack of transparency, poor fulfillment, and poor accountability practices. Travel premiums have even been under fire from the U.S. Attorney General's Office from time to time, resulting in increased laws, regulations, and penalties regarding advertising and fulfillment practices by promoters and suppliers. Given the management inefficiencies as well as public distrust of travel premiums under existing systems, many sponsors decide to forego the use of a potentially valuable business tool.

### SUMMARY AND OBJECTS OF THE INVENTION

The present invention comprises a central management hub for building, redeeming and fulfilling premiums. The present invention uniquely enables the automated management of expanded option premiums that are complex or that involve service-based rewards. Vendors, sponsors, salespeople, clients, developers, auditors, fulfillment houses, customers, and other users are able to interact with this central hub to fulfill their respective purposes. This management hub includes software that ideally is web-based and works in conjunction with human resources to simplify, track, monitor, report, and evolve various aspects of the fulfillment process, resulting in a centralized and efficient premium redemption and fulfillment system that has been shown to increase fulfillment rates by up to ten times while also significantly enhancing performance and profitability—and thereby delivering to consumers and suppliers what both prize the most, and enabling the ultimate restoration of positive public opinion and client confidence.

First, all users and premiums must be registered in a central database associated with the central hub. The registered premium preferably has various information encoded with it that allows its holder to validate, defend, and transfer ownership of the premium through a secure process using the latter web site. The holder can access descriptions of how to transfer, redeem, or otherwise use or manage the premium by using the password at a web site managed by the central management hub.

Once the premium is centrally registered, the present invention uses a unique redemption process that is novel in that the system has the flexibility to use computers, live fulfillment agents, or both to transact with each premium holder. Preferably, the holder desiring to redeem his premium enters a redemption request on a web site run by the central management hub. Preferably, electronic invitations are automatically sent out to authorized fulfillment agents querying them as to whether they would accept responsibility for redeeming this request. Authorized fulfillment agents connected to the hub 11 from anywhere in the world can electronically accept responsibility for redeeming the request. When an agent accepts a redemption request, he reviews any redemption request information provided by the central hub and subsequently contacts the end user to complete the redemption process.

The management hub may be used to redeem most types of existing premiums—whether the premiums are embodied in traditional or electronic representational media of any kind, including but not limited to printed or electronic vouchers, coupons, certificates, currencies, or notes, as well as credit card, smart card, identification card, or membership discount card style recording devices. Moreover, the premiums can represent a combination of more than one item, and include various terms and conditions that describe how the complimentary perishing gift item can be alternatively exchanged for something greater later on, like additional purchases that will cover any short-term loss. Preferably, where the premiums are travel bonds, all major airlines, cruise lines, and many top hotel chains participate in the system.

One unique aspect of the invention includes the ability for the premium end user to log in to a web site and use a shopping cart (or other suitable type of electronic application) to electronically manage his premiums in a variety of novel ways. For example, in some embodiments of the present invention, the end user may do one or more of the following: view, sort, check pricing, availability, or buy fee-based extensions to expiration periods. Some systems of the present invention may also automatically generate real-time progress reports or remind the end user of upcoming expiration dates. The invention may also provide for printable receipts and faxable submissions.

Another unique aspect of preferred embodiments of the invention includes the ability of the central management hub to easily provide customized sponsor branding throughout the system, including on the premiums and on the web redemption pages (such as, for example, using a trademark word within a first link from a sponsor's own web site to the hub's central redemption site). In some embodiments, a sponsor can tailor the specific wording or presentation of a premium based on pre-set preferences related to the individual premium end user.

Yet another unique aspect of preferred embodiments of the invention provides for optional insurance for the sponsor, the end user, or other users.

Finally, the central hub of preferred embodiments of the present invention provides for an integrated checks and balances system that gauges, monitors, and reports supply and demand and performance bottlenecks in real time. The central hub can also incorporate a search engine that provides comparisons of current market values. The central hub can further provide a central forum for end user and independent third party feedback relating to specific types of premiums. The feedback may tie in with a rating system that rates the performance of specific premiums.

Accordingly, it is an object of some embodiments of the present invention to provide a venue for the commercial exchange of premiums in which revenue streams are increased while simultaneously increasing fulfillment rates.

Another object of some embodiments of the present invention is to provide systems and methods for managing premiums that increase fulfillment rates by up to ten times existing fulfillment rates for travel premiums.

Another object of some embodiments of the present invention is to provide systems and methods for managing premiums that do not rely on breakage for profitability.

Another object of some embodiments of the present invention is to provide unique turnkey tools for enterprises to manage gift and incentive programs.

Yet another object of some embodiments of the present invention is to provide a computer-based venue for business-to-business commercial exchange of premiums.

A further object of some embodiments of the present invention is to provide a system for managing premiums that is able to easily work with multiple fulfillment agencies.

Another object of some embodiments of the present invention is to provide an automated exchange that offers both generic and customized premium packages.

Another object of some embodiments of the present invention is to provide a system for managing premiums that is usable for simple redemption procedures, but optimal and unique for complex redemption procedures.

Another object of some embodiments of the present invention is to provide a computer-based system that connects multiple levels of users in a many-to-many model, the system providing automated premium building, distributing, redeeming, and fulfillment services.

A further object of some embodiments of the present invention is to provide methods and systems for managing premiums, the methods and systems offering unprecedented levels of private labeling throughout the premium building, distributing, redeeming, and fulfillment processes—all at relatively little time and expense.

Another object of some embodiments of the present invention is to provide methods and systems for managing premiums that offer unprecedented levels of redemption options.

Another object of some embodiments of the present invention is to provide premium vouchers that offer a unique degree of security.

Yet another object of some embodiments of the present invention is to provide premium vouchers that track transfers between multiple levels of users, including between end users.

A further object of some embodiments of the present invention is to provide an easily monitored and audited system for managing premiums.

Another object of some embodiments of the present invention is to provide systems for managing premiums having means for helping to prevent a reseller's potential clients from discovering the reseller's sources so that the potential clients are not able to easily determine the reseller's sources and deal directly with those sources instead of with the reseller.

Another object of some embodiments of the present invention is to provide a computer-based system that enables a large commercial exchange of service-based premiums.

Another object of some embodiments of the present invention is to provide a central hub having modular elements that are each designed to manage typical tasks that a particular type of user may need to accomplish, each user having a password that accesses only those modules tailored to that user's needs.

A further object of some embodiments of the present invention is to provide an automated rating system for premiums.

Another object of some embodiments of the present invention is to provide a premium exchange that provides automated monitoring that allows a central managing entity to make real-time adjustments in order to manage breakage and system resources.

Another object of some embodiments of the present invention is to provide an automated way to simplify the building of premiums.

Yet another object of some embodiments of the present invention is to provide a premium exchange that combines computer-based systems with live human resources and that is usable in many contexts such as in the following environments: in-store, point-of-purchase, internet, direct mail, and telemarketing.

Another object of some embodiments of the present invention is to provide a premium exchange that may be totally electronic or may be a combination of electronics and human resources, the exchange requiring minimal training and resources to operate.

A further object of some embodiments of the present invention is to provide a referral management and rewards system that encourages the expansion of a commercial premium exchange via a central hub.

Another object of some embodiments of the present invention is to provide an automated premium management system that allows a fulfillment agent to pass on passwords via a central hub so as to encourage expanded distribution of premium packages.

Another object of some embodiments of the present invention is to provide premium vouchers that are easily and inexpensively modifiable.

### BRIEF DESCRIPTION OF THE DRAWINGS

The foregoing and other objects and features of the present invention will become more fully apparent from the accompanying drawings when considered in conjunction with the following description and appended claims. Other objects will likewise become apparent from the practice of the invention as set forth hereafter. Although the drawings depict only typical embodiments of the invention and are thus not to be deemed limiting of the invention's scope, the accompanying drawings help explain the invention in added detail.

FIGS. 1A and 1B illustrate some computer-related elements in accordance with some embodiments of the present invention.

FIGS. 2A through 2C show, in accordance with some embodiments of the present invention, an example of the process of building premium packages.

FIGS. 3A and 3B illustrate, in accordance with some embodiments of the present invention, means by which a sponsor or other business user may order premium packages.

FIGS. 4A and 4B show, in accordance with some embodiments of the present invention, some ways that a premium package may be customized.

FIGS. 5A through 9 illustrate, in accordance with some embodiments of the present invention, some features of the premium redemption and fulfillment process.

FIG. 10 shows, in accordance with some embodiments of the present invention, a web-based home page interface that various users might use to access the central hub.

### DETAILED DESCRIPTION OF EMBODIMENTS OF THE PRESENT INVENTION

The following detailed description, in conjunction with the accompanying drawings (hereby expressly incorporated as part of this detailed description), sets forth specific numbers, materials, and configurations in order to provide a thorough understanding of the present invention. The following detailed description, in conjunction with the drawings, will enable one skilled in the relevant art to make and use the present invention.

One purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth only for explanatory purposes, that this description is not intended to limit the invention to these particular embodiments. Indeed, it is emphasized that the present invention can be embodied or performed in a variety of ways. The drawings and detailed description are merely representative of particular embodiments of the present invention.

It should be noted that since some embodiments of the present invention are computer-implemented, particular embodiments may include computer executable instructions as part of computer readable media, as well as hardware used in conjunction with these executable instructions. Further, when the invention is described in the context of computer readable media having computer executable instructions stored thereon, it is emphasized that the instructions may include program modules, routines, programs, objects, components, data structures, etc. that perform particular tasks or manipulate data within various structures of the computing environment. Executable instructions may comprise instructions and data which cause a general purpose computer, special purpose computer, or special purpose processing device to perform a certain function or group of functions.

In addition, computer readable media may comprise any available media that can be accessed by a general purpose or special purpose computer. By way of example and not limitation, such computer readable media can comprise RAM, ROM, EEPROM, CD-ROM or other optical disk storage, magnetic disk storage or other storage devices, or any other medium which can be used to store the desired executable instructions or data and which can be accessed by a general purpose or special purpose computer. Combinations of the above types of media should also be included within the scope of computer readable media. For brevity, computer readable media having computer executable instructions may sometimes be referred to as “software.”

Reference will now be made in detail to several embodiments of the invention. The various embodiments will be described in conjunction with the accompanying drawings wherein like elements are generally designated by like alphanumeric characters throughout.

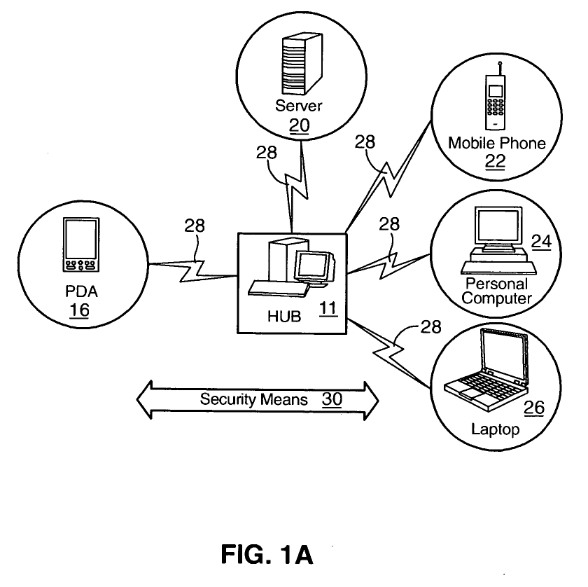

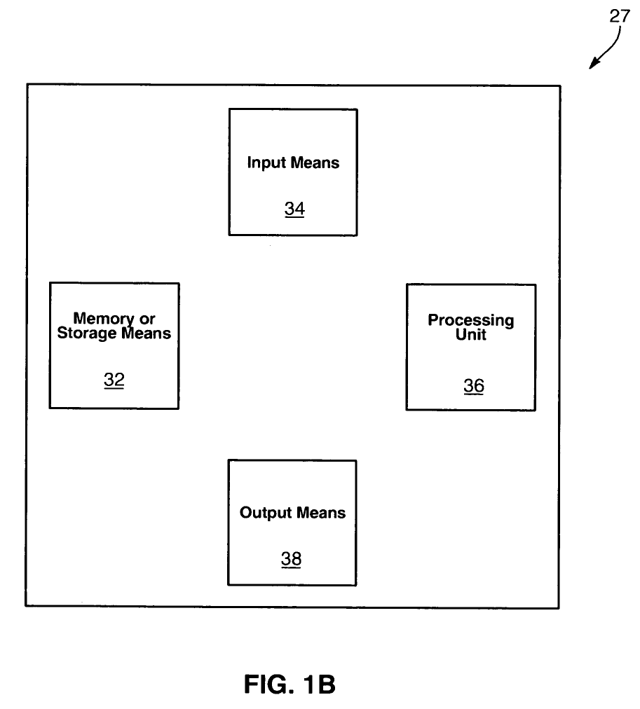

FIG. 1A shows some possible physical components in some embodiments of the present invention. In the preferred embodiments, a central managing entity controls a central management hub 11 and permits multiple types of users to have access to the hub 11. The hub 11 comprises one or more computer-type devices and a software application that preferably comprises multiple modules, a central database, and a web interface that allows multiple types of users to communicate and interact with the hub 11.

FIG. 1A shows some specific examples of computer-type devices that users or entities may use to connect to the hub 11. To communicate with the hub 11, a user may use one or more computer-type devices such as a personal digital assistant (PDA) 16, a server 20, a mobile phone or smart phone 22, a personal computer 24, a laptop computer 26, or other computer-type device as generally represented at 27 in FIG. 1B. The typical computer-type device 27 includes a memory or storage means 32, an input means 34, a processing unit 36, and an output means 38. As was mentioned earlier, memory or storage means 32 can include any type of media, including but not limited to: RAM, ROM, EEPROM, CD-ROM, magnetic cassettes, flash memory cards, digital video discs, floppy disks, removable disks, cartridges, smart cards, or any other optical or magnetic media. Input means 34 may include a keyboard, a pointing device (for example, a mouse, touch pad, track ball, joystick, or stylus), a microphone, scanner, or any other sort of suitable input means. Examples of output means 38 include but are not limited to: a monitor, a printer, a plotter, a fax, and audio speakers. The present invention is not limited to the computer-type devices that have been herein named, but may incorporate any other computer-type device that performs the relevant functions.

Users connect to the hub 11 via data communication means, shown generally at 28 in FIG. 1A, which may include a wireless means, a wired line, a cable modem, satellite dish, or other communication means. The users of the hub 11 preferably access the hub 11 via the global Internet or other globally networked system; however, in some embodiments, they may access the hub 11 via a local-area network (LAN) system. Data communication means 28 may include a network adaptor or modem for establishing connections to the Internet or to the LAN system.

Various protocols may be used for communication between the users and the hub 11. For example, a PDA-using user might communicate via wireless application protocol (WAP). Also, in some embodiments of the present invention, the hub 11 provides a platform that transforms data into a format suitable for use in a wide variety of wireless networks, including but not limited to networks using Code Division Multiple Access (CDMA), Global System for Mobile Communication (GSM), Time Division Multiple Access (TDMA), Cellular Digital Packet Data (CDPD), Mobitex, and Internet Protocol. The hub 11 is preferably extendable across a wide variety of protocols, operating systems, and networks.

The hub 11 preferably also incorporates a security means 30 so that data communicated through the hub 11 is secured from access by unauthorized intruders. In preferred embodiments of the present invention, the security means 30 includes user ID and password mechanisms, but may include any sort of suitable security means. Some embodiments of the present invention further incorporate cryptology protocols such as Secure Socket Layer (SSL) and Transport Layer Security (TLS). Some embodiments may also incorporate Public Key Infrastructure (PKI) technology that supports digital signatures.

As was mentioned earlier, the hub 11 comprises a software application that preferably comprises multiple modules. The software application can internally incorporate a module, or simply provide the interface that operates upon information held in an external module that is external to the software application. The software application is preferably designed to be easily modifiable, extendable, and to be able to easily accept additional modules. The software application may be designed to allow certain users to access only certain modules or portions of the hub 11. Some examples of modules include but are not limited to: databases, modules designed for use by a specific type of user, applications that provide for automatic bank and credit card account tracking and reconciliation; applications that provide for online bill payment; applications that allow bills to be presented online; applications that let a user make payments via e-mail; applications that provide point-of-sale tools; applications providing a personal credit card processing tool; applications providing automatic reports; and applications that allow a user to conduct online financial transactions with another entity such as a financial institution or a merchant, and applications that provide traditional-type financial accounting analysis and reports. In some embodiments, the software application incorporates all or some of the above features internally; in some embodiments, all or some of the modules are external applications that interact with the software application.

The software application preferably operates in a graphical user interface (GUI) environment wherein users can manipulate data and information using pointing devices such as a mouse, roller ball, or PDA stylus. As such, the application preferably operates within a Windows-type environment. The software application is preferably web-based, but it may also be hosted as modular software on an individual computer device, or hosted in any other workable way.

The software application may reside in various computer-related storage media within the central management hub 11. The software application may also reside, in whole or in part, in the same storage media as does other software, including but not limited to: operating system software, other software applications or program modules, and data. Moreover, any software applications, program modules, or data in the central hub 11 may be stored in whole or in part in a local or remote computer storage device or means, as well as be linked to various processing devices for performing certain tasks.

Embodiments of the present invention generally comprise a unique computer-based central management hub 11 managed by a central managing entity that together interact with multiple types of users to manage premiums at several levels. A “premium,” for purposes of this paper, is an incentive or deal delivered by or on behalf of a sponsor to an end user, the end user receiving a voucher, certificate, or other representation (herein generally referred to as a “voucher”) that allows the end user to redeem the voucher for a reward. A premium package is one or more premiums prepared for sale or distribution to sponsors via the central management hub 11. A sponsor is a business individual or entity that purchases one or more premium packages to use as incentives for end users with respect to a particular purpose adopted by the sponsor, which purpose typically includes promoting the sponsor's business or business objectives. Premium packages of the present invention are not intended to be purchased directly by, or distributed directly to, the end user; rather they are intended to be available for sale or barter between businesses that use the central hub 11. This paper shall refer to the former characteristic as a “business-to-consumer” model of consumption, and the latter as a “business-to-business” model of consumption. It shall be noted that references to a “sale” or “sales” herein need not refer to transactions involving monetary consideration or profits, but such references also refer to other means of transfer or distribution, including those involving barter, cash, or charitable donations.

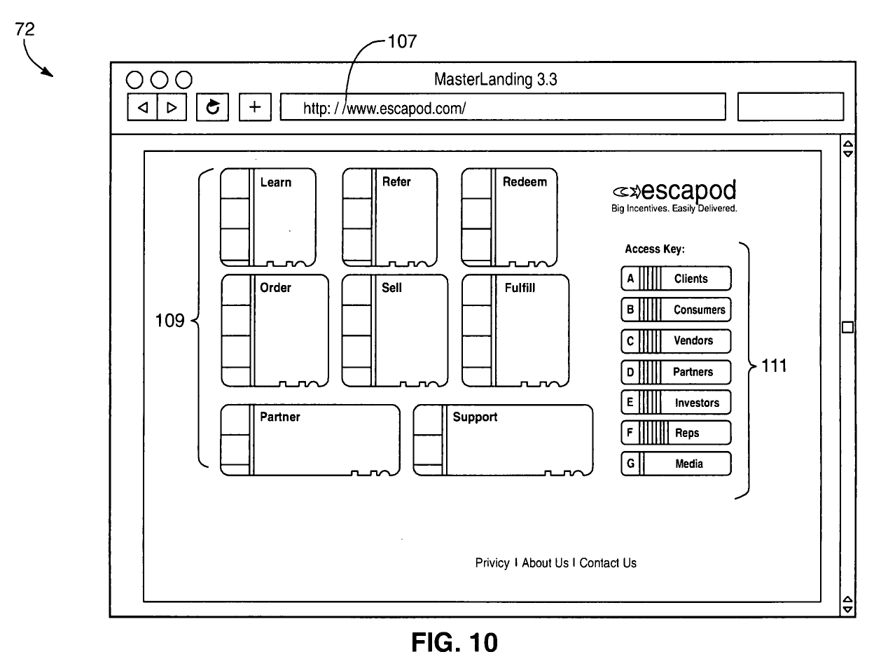

As was mentioned previously herein, the central managing entity uses the central hub 11 to manage premiums at various levels. Such management may include one or more of several functions, including but not limited to: preparing premium packages, facilitating the business-to-business sales of premiums and/or premium packages, distributing premium packages to sponsors, facilitating the tracking, redemption, and fulfillment of premiums, and providing multiple unique services relating to the premiums. As was also mentioned previously herein, the central hub 11 preferably comprises a web-based user interface that various users can access. An example of such an interface is shown, for example, at 72 in FIG. 10, and shall be discussed, along with other aspects of embodiments of the present invention, in more detail further herein.

Types of Users

Various types of users may use and access the central management hub 11. Some examples of users can include, without limitation: (1) a central managing entity that manages the hub 11 and the processes associated with the hub 11; (2) an end user, or person for whom a premium is intended to be redeemed; (3) a sponsor; (4) a supplier, or person or entity who makes the premiums available for sponsors to purchase (examples of suppliers include but are not limited to middlemen such as consolidators or resellers, as well as direct vendors of the rewards underlying the premiums, such as airlines, cruise lines, hotels, or product manufacturers); (5) a fulfillment agent, or person who helps the end user to fully redeem his or her premium (examples of fulfillment agents include but are not limited to those who are independently associated with the central managing entity, such as independent travel agents or employees or agents of the sponsor or supplier, as well as those who are employees or hires of the central managing entity); (6) salespeople, including independent resellers and consolidators as well as persons who sell premium packages to sponsors on behalf of the central managing entity (examples of salespeople include but are not limited to employees or hires of the central managing entity, as well as independent individuals or entities who partner or affiliate with the central managing entity); and (7) potential investors who may want to invest money into the central managing entity that manages the hub 11.

Other users that might interact with the hub 11 include but are not limited to: print vendors who create designs and submit them for press, web vendors who design and develop web interfaces, call center vendors who set up and execute call center operations, mail house workers who stuff, pack, label, and ship items to be mailed, advertising workers, technical support providers, software developers or programmers, computer technicians who may incorporate third-party add-ons or modules to the hub 11, customer service providers, the media, and the public. It shall be noted that the phrase “via the hub 11” is intended to be broadly interpreted and can refer to directly accessing the computer systems of the hub 11, or to indirectly accessing the hub 11 via a salesperson who in turn directly accesses the computer systems of the hub 11. Also, it should be noted that many of these users, while herein described separately, could actually be one and the same. For example, in some embodiments of the present invention, the supplier and the sponsor can be the same person or entity. In preferred embodiments, all users must register themselves with the hub 11 before entering into any transactions using the hub 11.

Types of Premiums

A premium may be redeemable for any type of underlying reward or combination of rewards, including services, tangible merchandise or products, or monetary discounts for services or products. Examples of some types of services include but are not limited to: travel (such as lodging, air, land, or sea transportation, etc.), professional services, beauty makeovers, house-cleaning services, accounting services, dietician services, personal finance consulting, psychology services, and education consulting. Examples of some types of merchandise include but are not limited to: electronics, flowers, gourmet food, candy, beverages, health-related merchandise, beauty-related products, jewelry, indoor or outdoor sports gear, toys, products geared toward a certain age group (infants, teens, etc.), apparel and accessories, and car supplies. Examples of monetary discounts include but are not limited to: rebates, percentage discounts (such as “fifty percent off”), and “buy one get one free” deals.

Premiums may be offered to an end user based on various qualifying conditions or for various reasons chosen by the sponsor. For example, a premium can be offered to an end user who buys a certain type of product or service, a certain number of products or services, or pays a certain amount for products or services. Other qualifying conditions might include if the end user donates a certain amount of money to a certain charity, or is an employee who meets certain performance goals. A sponsor might also choose to simply give a premium to an employee/end user as a Christmas bonus. Also, in some embodiments of the present invention, the premiums have redemption conditions that allow the end user to redeem the premiums only if the end user meets certain conditions such as attempting to initiate redemption by specified expiration dates, booking travel within non-blackout dates, etc. One possible valuable type of premium enabled by the systems and methods of the present invention might involve one or more of the following: an award of air travel that lacks any limitation on the number of air travel premiums that the particular end user can receive; an award that lacks any blackout dates for usage; and an award that may be redeemed by the end user for a period of up to three years.

In the preferred embodiments of the present invention, the premiums offer the end user multiple levels of choices with respect to the underlying reward (herein referred to as “expanded option premiums”). In particular, the preferred expanded option premiums offer one or more of: 1) numerous options for each choice (in other words, large choice groups), 2) numerous categories of choices (in other words, numerous choice groups), 3) categories of choices that differ significantly from one another (in other words, disparate choice categories), and 4) unique types of options. Examples of expanded option premiums having large choice groups include, for instance, premiums that award an end user: a choice among 50 jewelry items; a choice of almost unlimited travel dates; a choice of a hotel among 100 particular hotels, a choice of a travel destination among 75 particular travel destinations. Examples of expanded option premiums having numerous choice groups include, for instance, premiums that award an end user a choice of one among each and every of the following groups: a group of 20 airlines that provide air service to Orlando, Fla., a group of 60 hotels located in or near Orlando, Fla., a group of 20 types of attraction tickets for attractions located in or near Orlando, and a group of 30 golf courses located in or near Orlando. Examples of expanded option premiums having disparate choice categories include, for instance, premiums that award an end user a choice of one reward from each of: a service-based reward category (like travel or entertainment), a merchandise-based reward category (like a watch or jewelry), or a discount-based reward category (like twenty percent off of a purchase). Examples of expanded option premiums having unique types of options include, for instance: premiums that allow an end user to freely transfer his premium voucher to another end user via the central hub 11, and premiums that give the end user the option to pay a fee to insure against loss of use or fulfillment (due to, for example, redemption overage, theft, loss, counterfeit/duplication of the vouchers, inability to travel due to last-minute emergencies, etc.)

In some embodiments of the present invention, the end user may redeem his premium via a points-based system. For example, a sponsor might deliver a number of points to the end user, the points being redeemable for various rewards listed in a catalog. In some embodiments, the points-based system may be combinable with a third party's points-based system. In some embodiments, the points-based system may be run among affiliated entities such as among franchises or online versions/equivalents of brick-and-mortar stores, or in conjunction with online games, web sites, lotteries, raffles, auctions, etc.

Some specific ways of offering expanded option premiums to end users include but are not limited to the following: (1) if a customer buys three months' of a sponsor's services, then the sponsor will give the customer two complimentary round-trip airfares to one of fifty top North American travel destinations, two local attraction tickets, and a free round of golf at any course within one hundred miles; (2) if a donor gives two hundred dollars or more to a public broadcasting station during a telethon, then the station will send the donor a video series on DVD, VHS, or on tape; (3) if an employee of a sponsor exceeds a sales goal of obtaining a certain number of new subscribers by a certain deadline, then the sponsor will give the employee a choice of one of fifty mens' or ladies' jewelry items; (4) if a sponsor's staff member has a baby, celebrates an anniversary, has a birthday, or has a child graduate from college, then the sponsor will give the staff member a complimentary merchandise gift to be chosen by the staff member from a mini-catalog designated and themed for that particular event, each theme catalog having over fifty items that each have a retail value of one hundred dollars or more; (5) if a customer makes a merchandise purchase worth over a certain amount of dollars at a sponsor's store, then the sponsor will give the customer a complimentary handheld electronic device.

It shall be noted that the reward underlying the premium can originate from internal or external sources. For example, if the sponsor is a photography studio, an external reward could be Disneyland tickets, and an internal reward could be a fifty percent discount off of any of that studio's portrait packages.

One unique type of expanded option premium that may be enabled by systems and methods of some embodiments of the present invention is an open-vendor premium. One example of an open-vendor premium is a premium that specifies that the premium is good for air travel but doesn't specify or limit the air travel to any particular airline. With such type of premiums, any qualifying airline can do so, including those airlines that may register with and submit their air travel packages to the central hub 11 after the premium was delivered to the end user, but before the end user has begun the process of redeeming the premium. The same type of open-vendor premium could be available with respect to other vendor categories besides the airlines, such as cruise lines, hotels, car rental companies, etc., as well as to non-travel related vendors.

In some embodiments of the present invention, another type of unique premium is enabled in which the value of the premium varies depending on the time it takes for the end user to redeem the premium. In one example of such a time-dependent premium, the longer the end user waits to redeem the premium (but before any applicable premium redemption period expires), the greater the value of the premium's reward. An example of increasing the reward for last-minute redeemers might be to give ten percent off of coach class airfares if the end user redeems the premium within four months of the original issue date, and twenty percent off of coach class airfares if the end user redeems the premium within twelve months of the original issue date.

Systems and methods of the present invention are able to offer these types of unique expanded option premiums because the central hub 11 provides a convenient, central, efficient, and automated way to bring together multiple types of users that are unable to come together in such a fashion under existing systems. The convenience and efficiencies of the systems and methods of the present invention are expected to draw an unprecedented number of suppliers, vendors, and other business users (that is, not end users) to participate in the commercial exchange enabled by the present invention. The large supply of premiums will result in lower costs to sponsors and greater choices to end users. As the unique premiums of the present invention are distributed to more and more end users, the reputation and value of the premiums will increase among the end user population. In turn, even more business users will be drawn to participate as the premiums will become increasingly valuable for use as incentives by sponsors. It is intended that the majority of the premiums shall be inherently cost-effective to the business users as a result of the premiums being bought or bartered for in large quantities via the central hub 11—and therefore the business users need not rely on breakage for profitability. The large quantity exchange results in a system that provides premiums at year-round cost-effective rates that need not rely on the use of premiums that are usable only during low demand seasons—a practice typical with currently existing premiums in some industries such as the travel industry (an example of a year-round rate premium could be one that rewards airfare without any blackout dates). The lack of reliance on breakage is a significant innovation in the industry, particularly with respect to travel-related premiums.

Preparing A Premium Package

Premium packages typically originate with a pre-qualified supplier (that is, a supplier who has been identified by and meets certain criteria set by the central managing entity) who submits a proposal for a set of one or more premiums to the central hub 11 in accordance with some embodiments of the present invention. In some embodiments, the supplier directly logs into the central hub 11 and electronically submits the necessary information (described further herein). In some embodiments, a live person helps the supplier submit the information or submits the information on behalf of the supplier. Examples of such live persons include but are not limited to employees or developers who work on behalf of the central managing entity, as well as independent developers who are registered with the central managing entity. Examples of suppliers include but are not limited to middlemen such as consolidators or resellers, as well as direct vendors of the rewards underlying the premiums, such as airlines, cruise lines, hotels, or product manufacturers. Other users can be involved in the creation of a premium package. For example, fulfillment agents such as travel agents can be part of the process and work together with the suppliers to create premium packages.

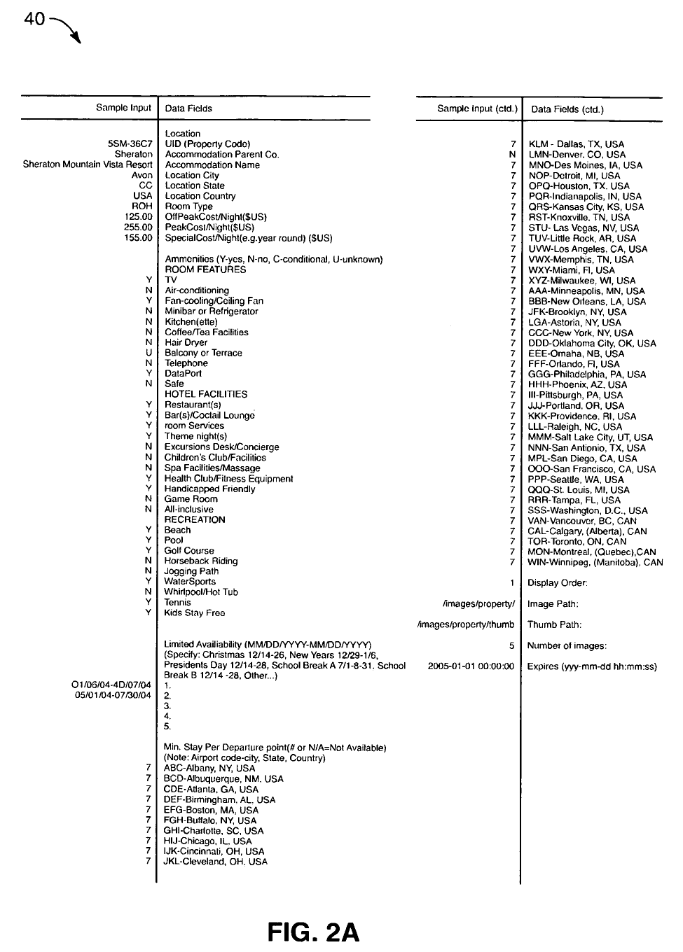

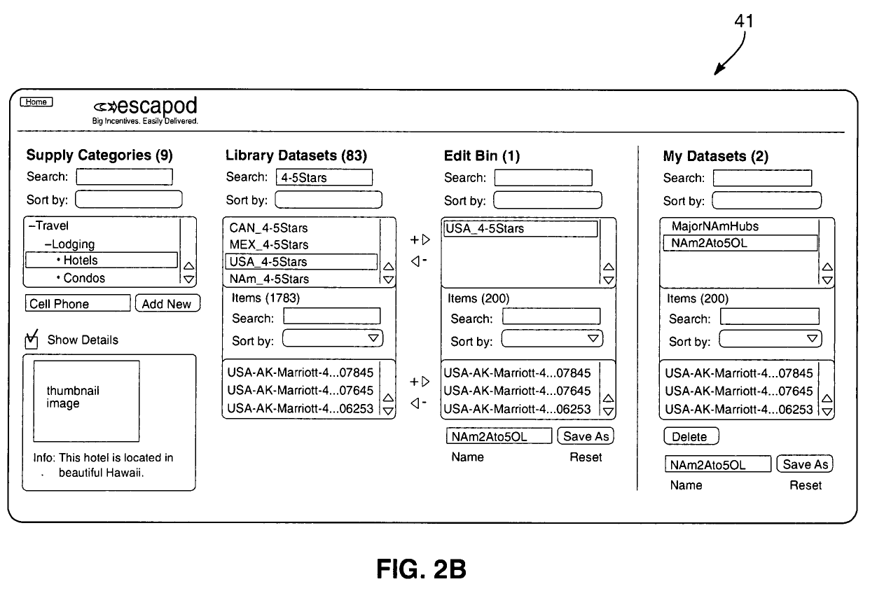

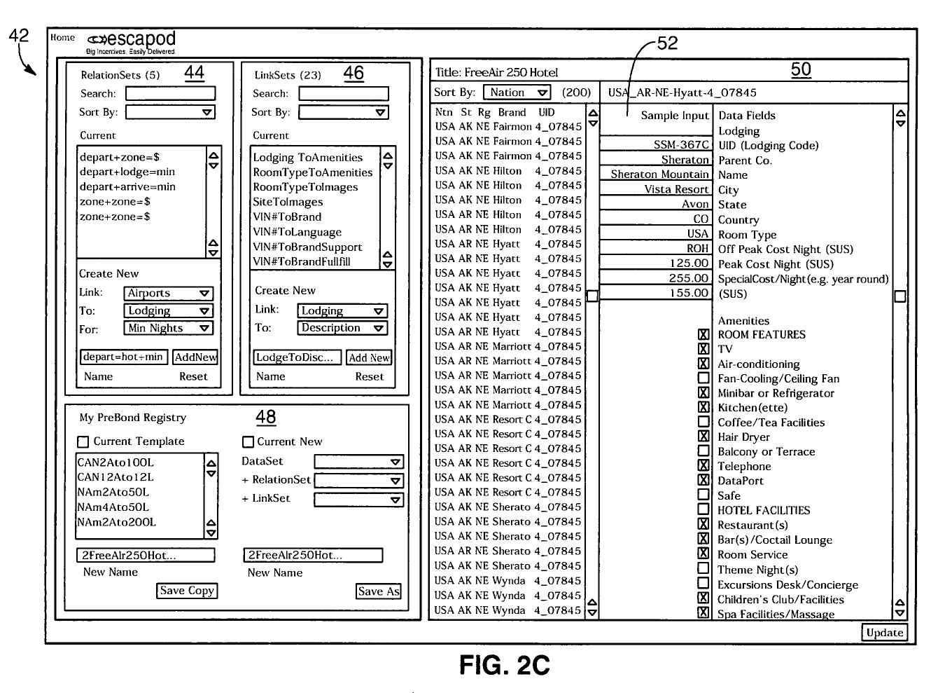

FIGS. 2A through 2C illustrate part of one way that a premium package may be created in accordance with some embodiments of the present invention. To facilitate the premium packaging process, and for the convenience of the supplier or person inputting the information on behalf of the supplier, the user may use an interface usable in connection with the central hub 11, the interface having one or more means for simplifying the process of building a premium package—for example, means for creating, editing, searching, sorting, categorizing, and saving customized groupings. For example, in order to build a bond, a user might make entries into data fields 40 that are part of a database of the hub 11. In some embodiments, the data fields 40 may be pre-populated and categorized by commonly chosen options so that the user need only choose from, for example, items in a drop-down list, for each field. In some fields of some embodiments of the present invention, the user may also type in new entries that then automatically are added to the drop-down lists or incorporated into other appropriate automated features. Specific examples of these types of fields that are pre-populated with a set of default entries which are intended to be added to as suppliers make additional entries may include but are not limited to the following: lists of North American airports, lists of lodging amenities (per room, per grounds, per recreation), lists of North American lodgings, room types, timers for expiration dates, and calendars for blackout or limited availability dates.

In one possible scenario involving an embodiment of the present invention, a supplier may want to submit a proposal for a package involving 4-star hotels. FIG. 2B shows one possible interface 41 that a supplier might use for this purpose. As shown in FIG. 2B, the supplier can search through a pre-defined drop-down list of award categories that could include hotels, airlines, cruises, products, discounts, etc. The supplier may then select “hotels.” This selection would then allow the supplier to further narrow his selection by selecting a category defined by, for example, 1-star, 2-star, 3-star, 4-star, or 5-star hotels. If the supplier selects “4-star hotels,” a list of 4-star hotels would populate a window for the supplier to view. In some embodiments, the supplier may then select or deselect specific hotels in the list of 4-star hotels and name and save his personalized selection of hotels as a dataset. The supplier may later recall his datasets and edit or use them as base elements from which to create other personalized selections.

Once the supplier in this example has saved his datasets, in some embodiments of the present invention, he may relate the datasets to each other using, for example, an interface 42 such as that shown in FIG. 2C. For example, assume the supplier in the previous example wants to offer end users two free airfares when they book one of the hotels, selected from those in the supplier's saved datasets, at designated room rates and for a minimum night stay. The supplier might then use: 1) a relationset creator 44 that allows the supplier to create data links that have a resulting value; and 2) a linkset creator 46 that allows the supplier to create simple two-way relationships between data elements. Element 48 in FIG. 2C also shows one way in which the supplier can save premium packages and use them as templates from which to base new packages. In the embodiment shown, a window 50 is populated after the datasets and their relationships are defined. The fields under a “Sample Input” column 52 are automatically populated as much as possible, but additional data may be entered at this window 50. Preferably, the creation of a premium package takes place with the help of a trained specialist who knows how to create the links and logic rules necessary to create the premium packages.

In the preferred embodiments of the present invention, it is contemplated that the hub 11 offers generic premium packages that can be bought by a sponsor or other business user as-is, but that most generic packages are used as templates for customized premium packages which are prepared in accordance with a particular reseller's or sponsor's needs. Generic premium packages can also be useful for salespeople who desire to demo the packages to potential buyers.

In preferred embodiments of the present invention, the creator of a premium package can designate whether a package is to be available for general use by other users of the hub 11, or whether the package is to be access restricted so as to be usable for the creator's own use only, or for use by other users specified by the creator. In some embodiments of the present invention, specific sections of a premium package can also be designed as access restricted if desired.

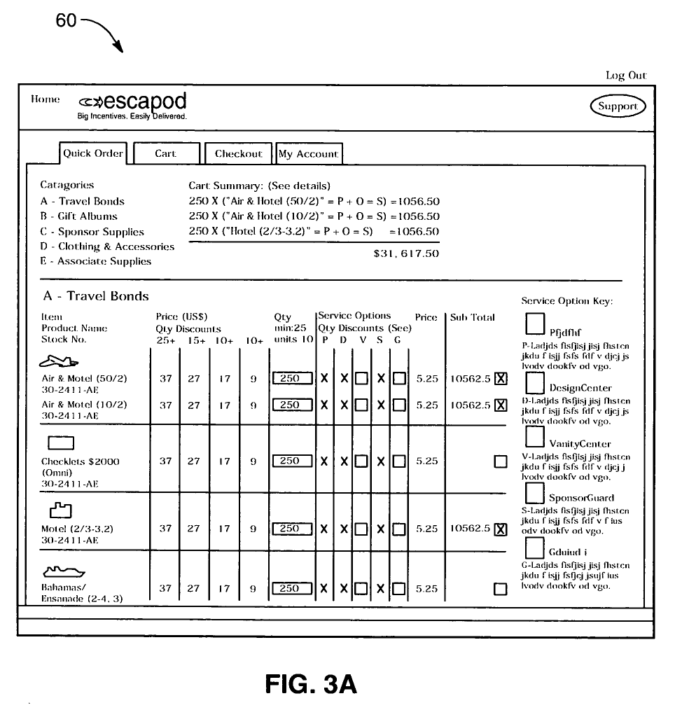

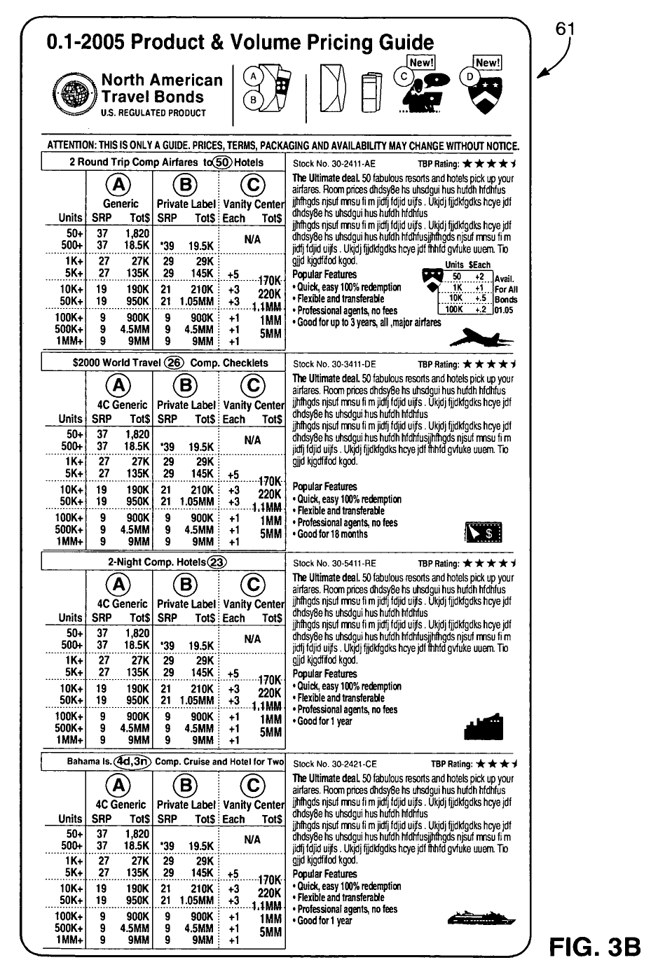

FIG. 3A shows a sample interface 60 whereby a user such as a sponsor or reseller might order a premium package. In some embodiments, business users can view, choose, and buy packages entirely via the hub 11 and/or may do so with the help of live support. In some embodiments of the present invention, as shown for example in FIG. 3B, a user might refer to a tangible brochure 61—such as one printed on paper, as opposed to being viewable on an electronic screen—when ordering and/or customizing a premium package.

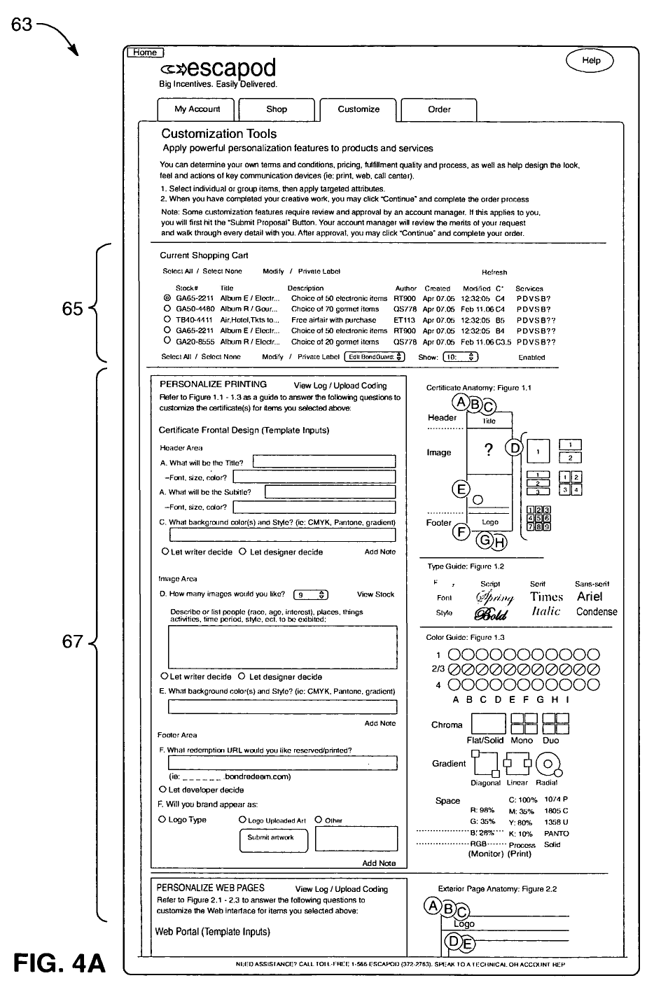

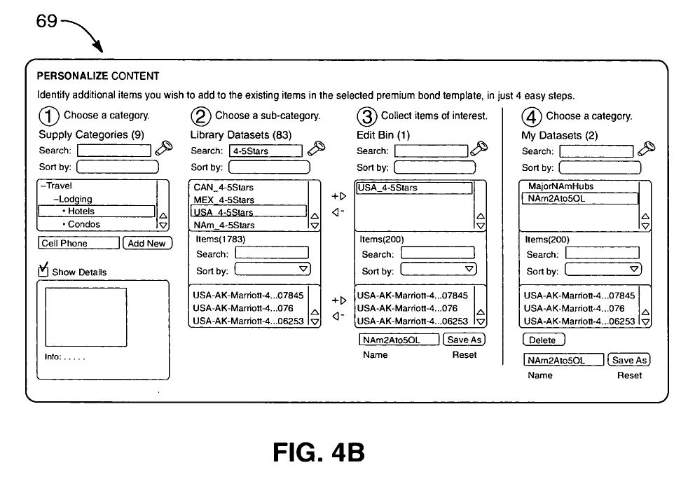

FIG. 4A illustrates a sample interface 63 whereby a user might customize a premium package by having private labeling or branding incorporated into the package. In some instances, a sponsor, reseller, or fulfillment agent or agency might desire to infiltrate a premium package with its own private branding, including word or logo trademarks, trade dress, or the like. Besides the obvious advantages of immersing users in a business's brand, using private labeling helps to hide the business user's sources of premium packages and thereby helps minimize competitors' abilities to steal a promotion campaign. It also helps prevent a potential client from discovering and attempting to deal directly with a salesperson's sources, which practice causes salespeople to lose potential sales. In some instances, however, a business user might desire to instead use the central managing entity's presence and branding throughout all or part of the premium package. It shall be noted that the placement of the ESCAPOD and XYZ marks located throughout the drawing Figures are only intended to be examples of branding and are not to be construed to limit or adversely affect any trademark or proprietary rights in such marks.

Elements in the premium package that may incorporate branding include, without limitation: brochures, vouchers, or certificates, whether tangible or electronic; web sites, including web site elements such as buttons, domain names, URLs, and links; e-mail and instant messages, including the e-mail addresses themselves as well as design and text elements in the e-mail or instant message contents; other electronic messages, including faxed matter and real-time messages; telephone and fax numbers; caller ID displays; scripts for live agents or salespeople; computer system messages, including syntax and references; voices; and identifiers. Unlike existing premiums that typically offer branding only on tangible reward certificates delivered to the end user, the premium packages of embodiments of the present invention allow users to be immersed with branding at multiple levels throughout the process of dealing with the premiums, including but not limited to during the creation, distribution, redemption, and/or fulfillment of premium packages.

Section 65 in FIG. 4A shows an example of how a user might select specific premiums for customization. Section 67 shows an example of how a user might easily submit pictoral and textual branding elements when ordering private labeling. In preferred embodiments of the present invention, the submission process is simplified and automated so that the user submits elements for specific pre-designated areas or target zones of the voucher, web site, or other item to be branded. Designating target zones minimizes the time needed to custom brand the premium packages, thereby minimizing the costs as well. As shown in FIG. 4A, the elements that the interface 63 may require a user to submit may include titles, subtitles, background colors or styles, images to be located in the pre-designated areas or target zones, etc. In some embodiments, the user can choose from stock elements instead of providing his own. When the user submits his own elements, the central managing entity, or someone who works on behalf of the central managing entity, need only quickly review the submissions and approve them for processing.

FIG. 4B illustrates another way of customizing a premium package—namely, by expanding on an existing set of reward options. For example, a sponsor might use an interface similar to interface 69 to add a dozen more Caribbean hotels to an existing basic choice of hotels. In the latter example, a sponsor might want to add the Caribbean hotels if the sponsor would like to provide incentives to end users who donate a specific amount of money to, for instance, a charity associated with the Caribbean such as a Caribbean hurricane relief foundation. In another scenario, a sponsor may want to add twenty top ski resorts if the sponsor intends to target potential buyers of snowboards.

The preferred embodiments of the systems and methods of the present invention offer multiple ways of customizing a premium package, including but not limited to offering one or more of the following: the option for a sponsor or other user to purchase insurance against loss of use or fulfillment (due to, for example, redemption overage, theft, loss, or counterfeit/duplication of the vouchers); the option for a sponsor to permit end users to insure and/or freely transfer their premiums to other end users; the option for a sponsor or other business user to designate a grade for its premium package (for example, “Consumer” grade for consumer promotions; “Business” grade for employee-type promotions; “Executive” grade for top executive-type promotions; and “Multi” grade for premiums that are suitable for all types of promo use); the option to designate different levels of service that an end user receives when in the process of redeeming his premium (the levels might be labeled, for example, “Gold,” “Silver,” or “Bronze”), the option to make customer support services available in one or more particular languages; the option to allow a reseller or other business user to expand and manage the distribution of passwords via the hub 11 in order to allow others to market and/or distribute the premium packages as well; the option to designate a future date when a premium is eligible for redemption by an end user; the option to have e-commerce enabled throughout the system.

In some embodiments of the present invention, the customization of premium packages can take place in a manner similar to the way data is entered and linked as previously described.

It shall be noted that once the custom choices for a premium package have been submitted, a programmer will preferably provide administrative finishing services to the package, thereby resulting in a finished premium package. These finishing services include ensuring that the package is operational and that logistics are properly built into it so as to ensure smooth operation. For example, the programmer might build in a rule to prevent an end user or travel agent from submitting or booking a flight itinerary beyond a specified expiration date. These finishing services can be very helpful in minimizing human errors and the use of valuable travel agent time in dealing with premiums.

It often takes weeks and even months to build customized premium packages using currently existing systems; the preferred systems and methods of the present invention significantly reduces this time to a mere few days.

Delivery of Finished Premiums to the Sponsor

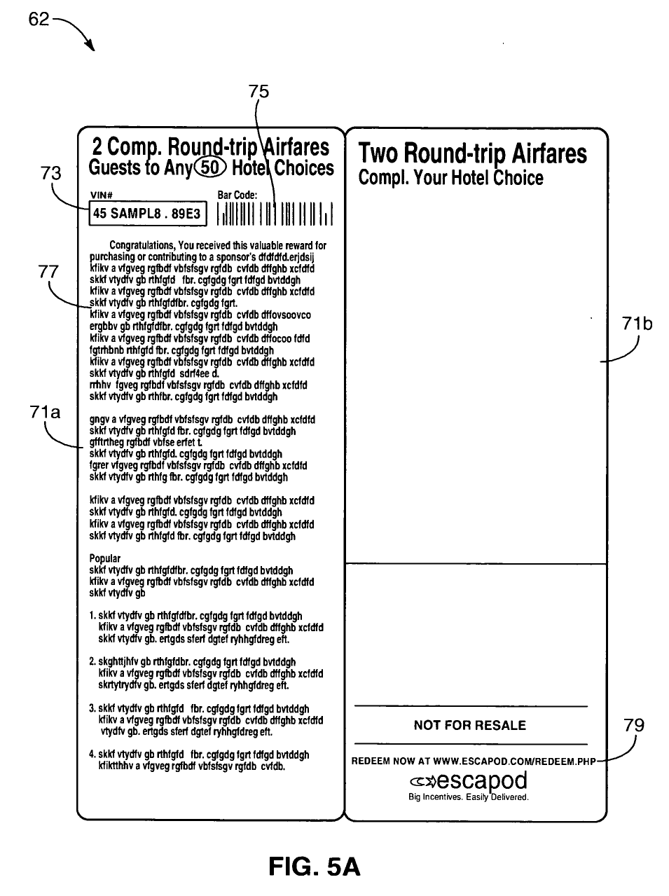

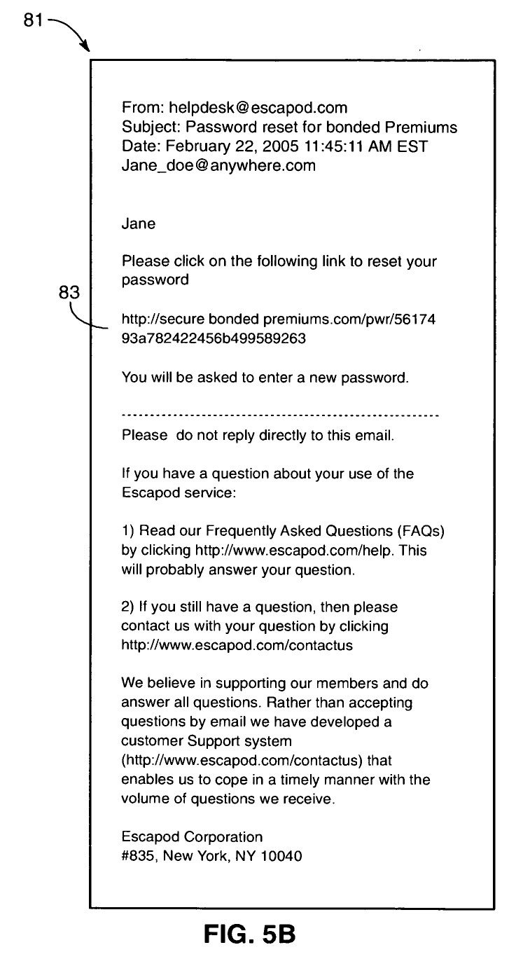

After the sponsor orders the premium package, the central managing entity delivers the premiums to the sponsor for the sponsor to arrange for delivery to its chosen end users. As was mentioned previously, the premiums may be delivered in the form of representations or combinations of representations herein generally referred to as vouchers. Some examples of vouchers include any type of electronic or tangible physical representation, including but not limited to: certificates printed on paper-type media, smart cards, electronic images of certificates, coupons, currencies or notes, credit cards, identification cards, or membership discount card style recording devices. FIG. 5A shows an example of a physically tangible certificate or voucher 62. Each voucher of the present invention has a unique identifier located on it (or incorporated into it) by which information about that voucher can be tracked. The identifier typically comprises and is herein referred to as a VIN (voucher identification number), as shown in this example at 73 of FIG. 5A. A scannable bar code 75 may also be located on the vouchers to aid in tracking and storing information about them. In some embodiments of the present invention, a shipping number may be integrated into the bar code 75 for ease in processing with digital equipment—so that printers, packagers, shippers, sponsors, auditors, and insurers can easily track each premium voucher. Preferably the VINs are not serial in sequence but are scrambled for security purposes.

Instructions 77 (here, the shown garbled text represents the instructions) may also be located on the vouchers to guide the end user as to how to redeem them for their underlying rewards. In preferred embodiments, the tangible vouchers of the present invention have a first side 71a and a second side 71b, the second side 71b having a designated area thereon for placement of a logo or picture (not shown) and a URL 79 by which the end user may register and initiate redemption of his voucher.

In some embodiments of the present invention, before delivery to the sponsor, the central managing entity places the VIN on the voucher. In other embodiments, VIN-less certificates can be provided to the sponsors for use in, for example, mass direct mail campaigns. As the recipients or end users of these VIN-less vouchers reply and qualify, the hub 11 issues a VIN in real time to the sponsor; the sponsor, in turn, gives the VIN to the end user so that the hub 11 can later recognize the authenticity of the voucher when the end user applies to the hub 11 for redemption of the certificate.

Sponsor Delivery to and Recordation of Specific End Users

In preferred embodiments of the present invention, the sponsor is preferably responsible for delivering the premiums to end users. At the time of delivery, the sponsor is responsible for recording the delivered premiums' VINs alongside identifying information about the end user who received each particular premium. Preferably, the end user information recorded is: (1) an e-mail or physical mailing address, and (2) another piece of universally identifying information such as, for example, a zip code, phone number, account number, Social Security number, or driver's license number. The sponsor then submits this information at regular intervals to the central managing entity. Preferably, the information is submitted electronically directly to the central management hub 11, but may also be submitted by any appropriate method, including by fax.

End User Redemption

When an end user bearing the premium desires to redeem the premium, he accesses the central management hub 11 (for example, via a designated URL or a telephone number) to register his voucher and formally identify himself to the hub 11. Registering the voucher turns it from a passive-issue voucher to an active-issue voucher. The end user is now permitted to enter an automated site of the hub 11 that allows him to redeem his premium. This site preferably gives the end user opportunities to search and view various choices and options related to the reward, some of the choices and options of which have been previously discussed herein. In some embodiments of the present invention, the central hub 11 can incorporate a search engine that provides comparisons of current market values. In some embodiments of the present invention, the users can pay a fee to extend deadlines or convert the value of a reward to a higher value. Preferably, the end user accesses the central management hub 11 by logging onto an Internet web page run by the central management hub 11. The end user then submits his preferences and makes his redemption requests preferably electronically via the web page, by e-mail, or by fax. However, it is understood that in some embodiments of the present invention, the end user may access and/or submit information to the hub 11 via any suitable method, including but not limited to: telephone (whether the information is taken by a live person or by an automated system), mail, e-mail, fax, or any other suitable method or combinations of methods.

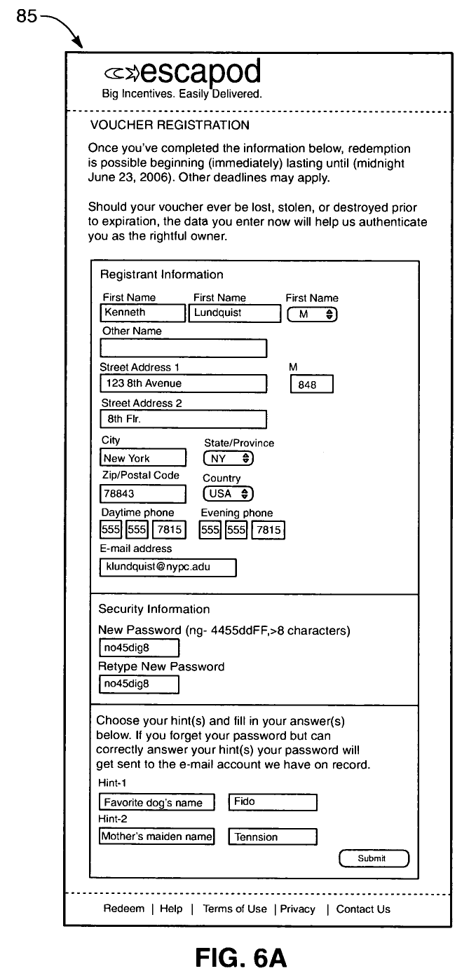

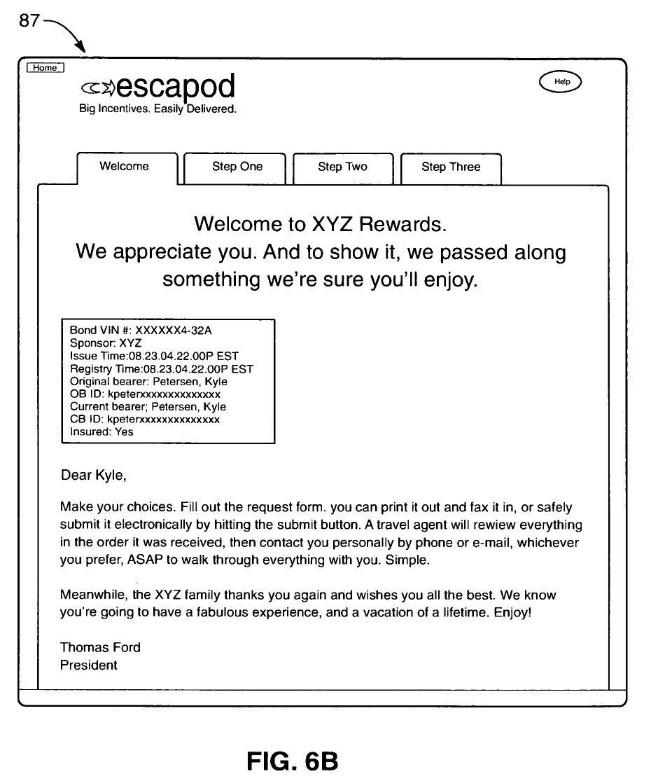

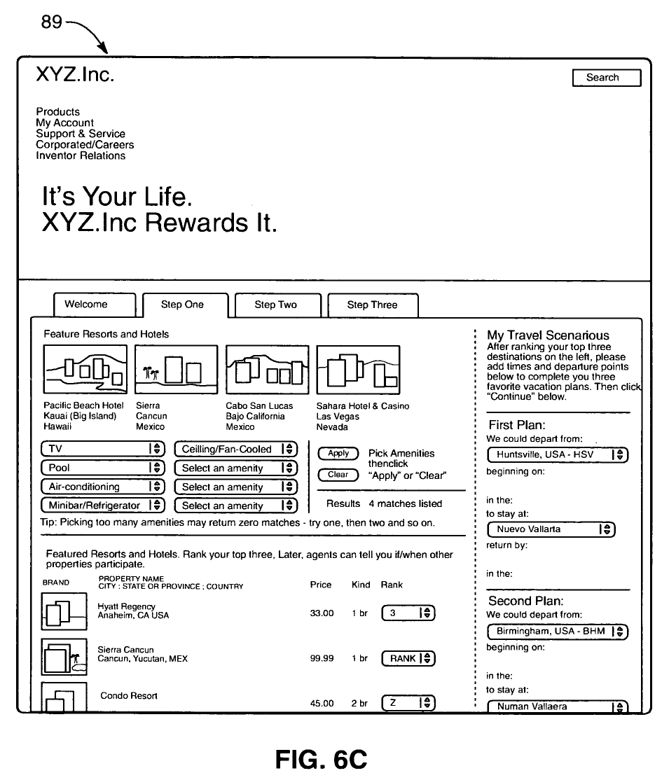

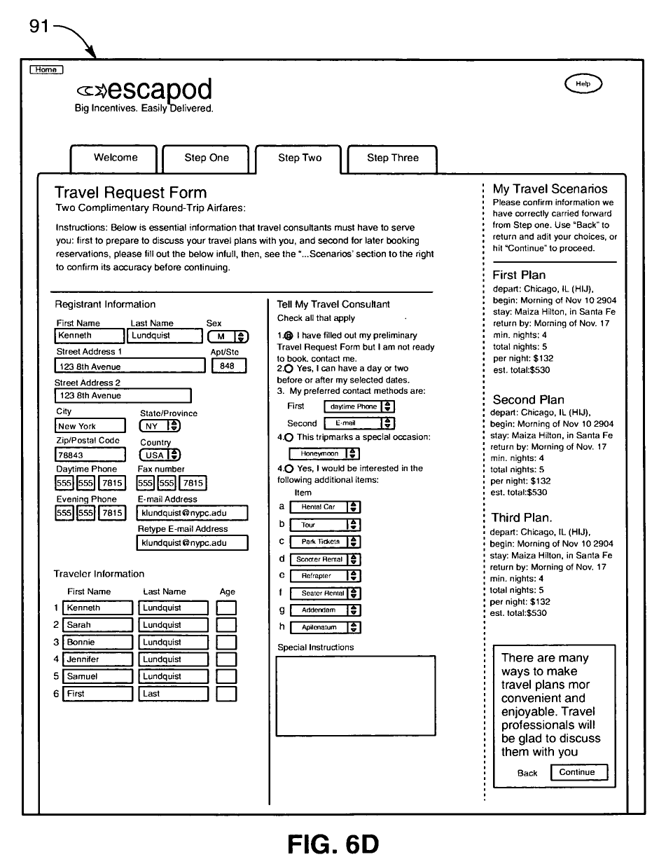

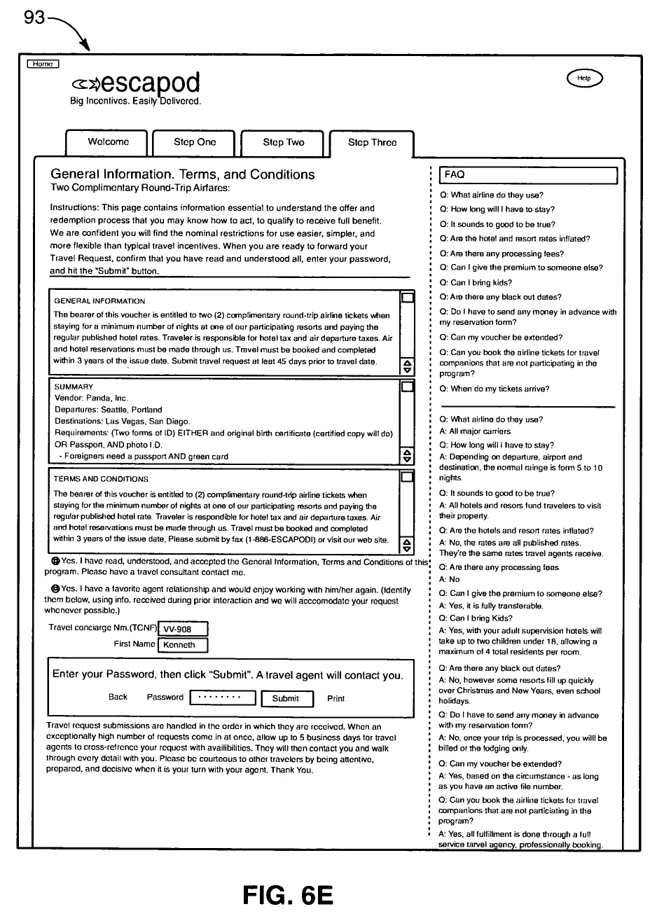

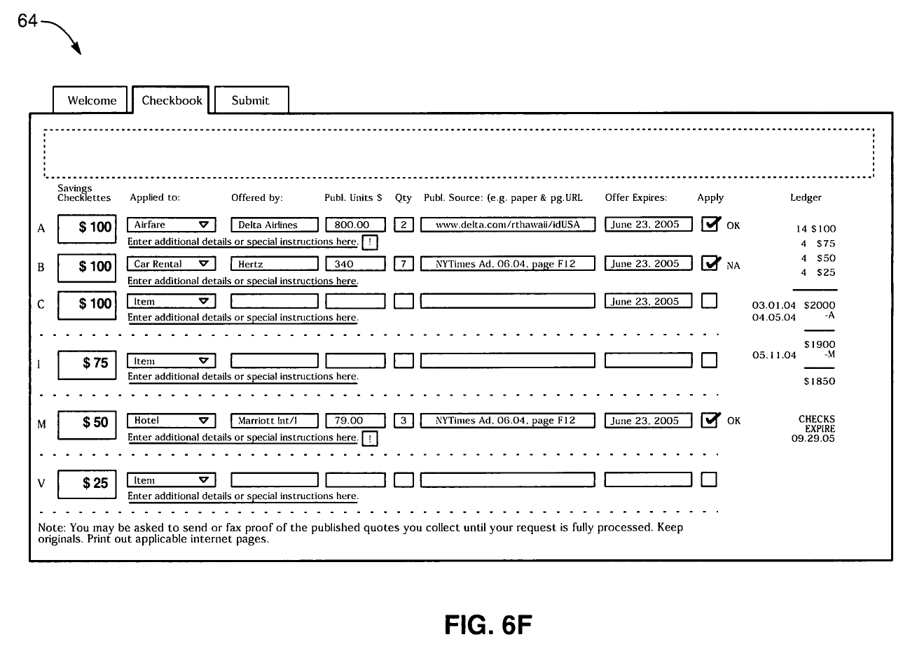

FIG. 5B shows, in accordance with some embodiments of the present invention, an e-mail 81 that the end user might receive, the e-mail 81 containing a link 83 to a web site of the hub 11 where the end user can register his voucher and subsequently begin the redemption process. FIG. 6A illustrates one interface 85 that an end user might encounter when registering his voucher. FIG. 6B illustrates one interface 87 that an end user might encounter when logging onto the central hub 11 after registering his voucher. FIG. 6C shows one interface 89 that an end user might encounter when purchasing the required hotel stay necessary to receive his reward. FIGS. 6D and 6E show some interfaces 91 and 93 that an end user might encounter when attempting to make a redemption request to redeem his award of two complimentary round-trip airfares. FIG. 6F shows a sample interface 64 whereby an end user may redeem a type of gift certificate premium (herein referred to as a “checklet”) that allows the end user to apply a gifted dollar amount to the purchase of the user's choice of air travel, a car rental, or other rewards.

Fulfillment Processed by Agents

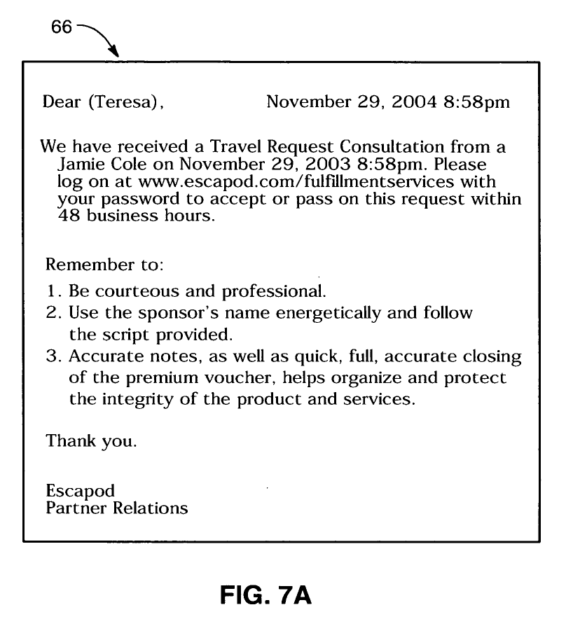

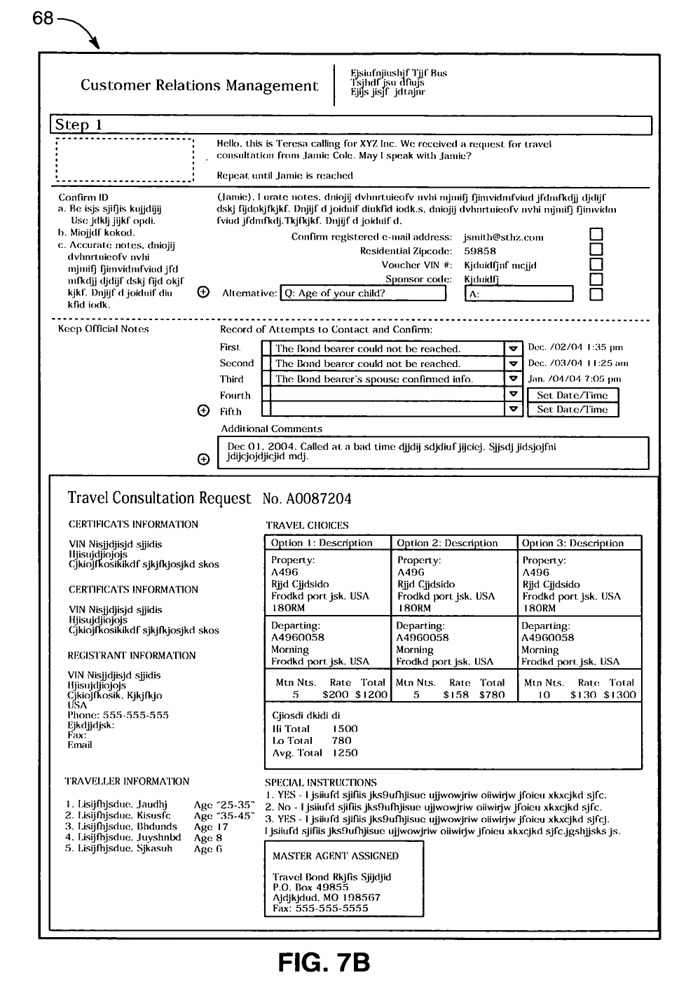

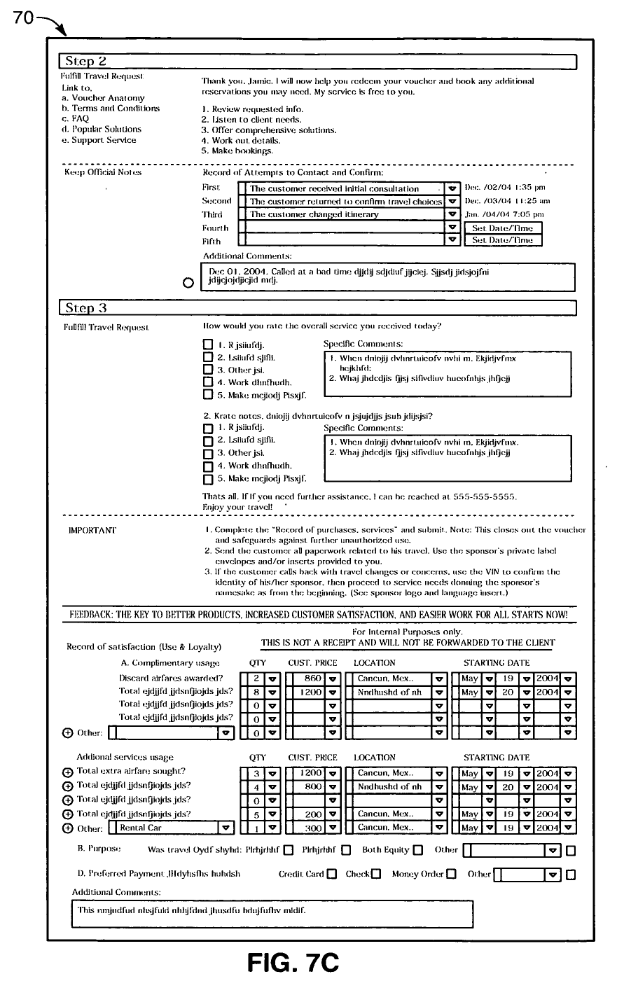

Once the end user submits his redemption request to the central management hub 11, the hub 11 preferably automatically routes his request to a fulfillment agent who has been registered in the central management hub 11's system. As illustrated in FIG. 7A, in the preferred embodiments of the present invention, the agent is notified of the user's redemption request via an e-mail 66 sent to the agent. The e-mail preferably contains in it a link to a web page in the hub 11 which takes the agent to a login page where the agent can enter his username and password. The means for notifying the agent need not be an e-mail, but can be a phone call, a fax, or any other suitable means of communicating to the fulfillment agent.

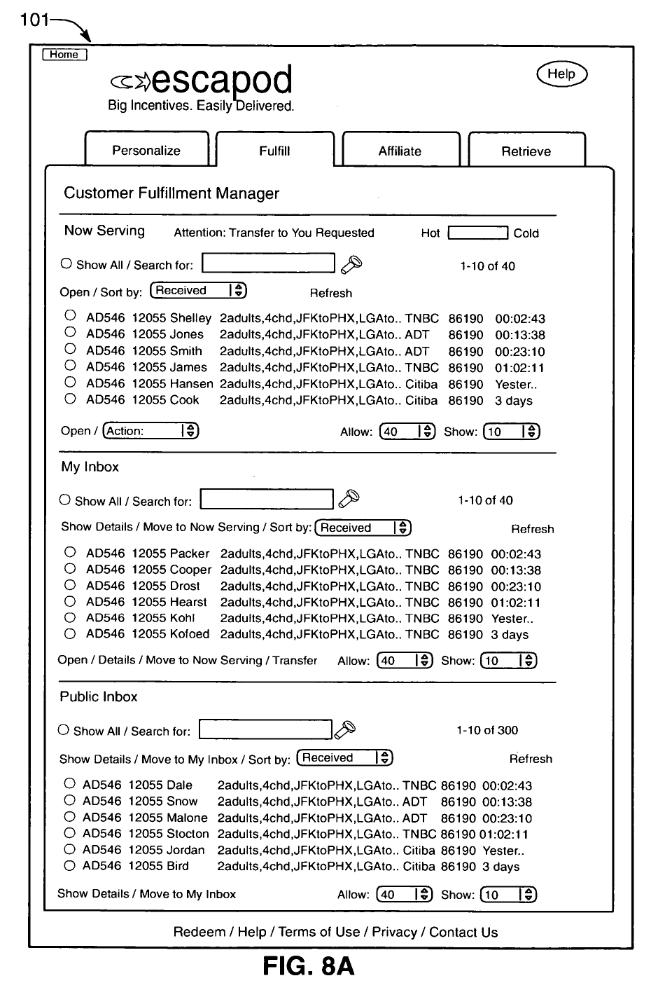

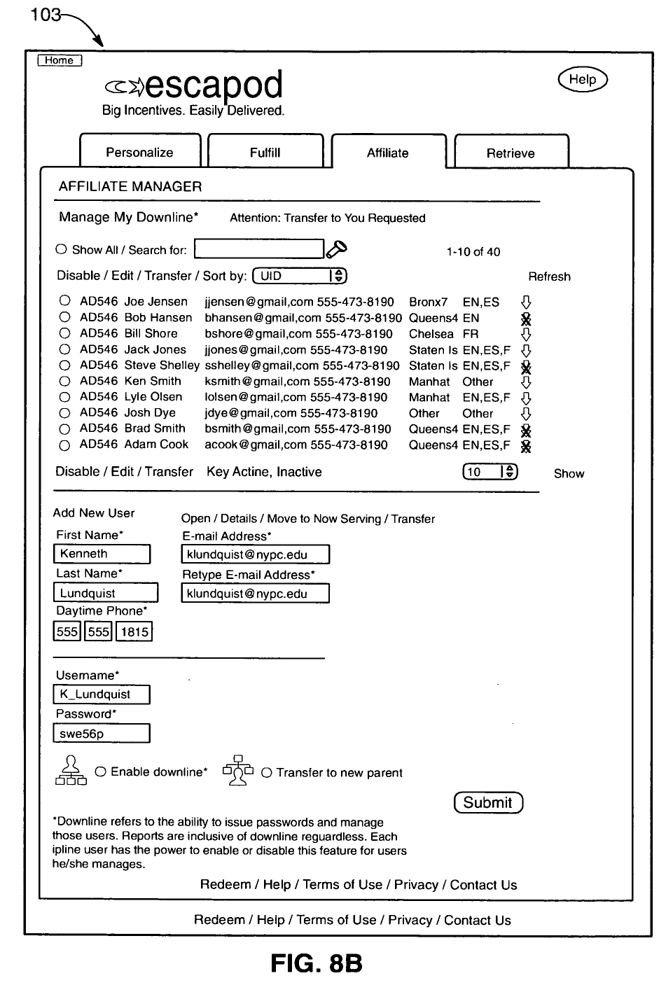

Once the agent is logged onto the hub 11, she will be able to view a list of redemption requests and accept or deny them. The agent may do one or more of the following via the hub 11: track and report progress, transfer clients/sponsors to another agent in case of illness or vacation, have upper management or other sales specialists oversee or assist in fulfillment, close premiums once redeemed so they are not re-usable, and give and receive communication with the hub 11 necessary to complete one's obligations in a timely and professional manner. FIGS. 7B and 7C show sample interfaces 68 and 70 that can aid the agent in fulfilling the end user's redemption request. FIG. 8A illustrates one interface 101 that a fulfillment agent might use to view and manage her redemption requests (the garbled text is meant to generally represent text).

In some embodiments of the present invention, fulfillment agents and other business users are able to distribute and manage the distribution of passwords via the hub 11 (which may be referred to as creating and managing a “downline”) to further encourage and expand the distribution of premium packages via the hub 11. FIG. 8B shows a sample interface 103 wherein an affiliate fulfillment agency manager is able to easily distribute passwords to multiple fulfillment agents within her agency, the passwords allowing access to the central hub 11. In other scenarios, a reseller or sponsor might create and manage downlines to increase their business.

Registration of Fulfillment Agents

Fulfillment agents register with the central management hub 11 by submitting various information about themselves and obtaining unique IDs whereby the central management hub 11 can identify the agent. Preferably, fulfillment agents register by logging onto an Internet web page run by the central management hub 11. However, in some embodiments of the present invention, the agents may register by phone, mail, e-mail, fax, or any other suitable method or combinations of methods. Examples of possible information an agent would submit could include, without limitation: fluency in any languages, and if the fluency is with respect to reading, writing, and/or conversation skills; travel license information; specialties such as in cruises, air travel, lodging, tours, geography, and domestic or foreign markets; contact information for each workplace location; billing information; workload preferences such as the number and kind of referrals that the agent is willing and able to handle per week; information about the computer equipment and systems that the agent uses and is familiar with, including whether the agent has access to computer systems at more than one location, and the type of computer equipment at each location. In some embodiments of the present invention, it is possible to register an entire fulfillment agency (such as a travel agency), as opposed to an individual fulfillment agent.

Central Interface

In the preferred embodiments of the present invention, all users of the central hub 11 may access the central hub 11 via a central interface. FIG. 10 shows an example of such an interface with a URL 107 and various modules 109 that preferably have user-specific access. In this particular example, when a user rolls his mouse over his appropriate button 111, the modules 109 that he can access will be highlighted. The highlighted modules indicate those modules in the hub 11 that the user will be able to access. In this embodiment, the “Learn” module is designed to educate the general public about the system; the “Order” module is designed to allow a business user to order premium packages; the “Refer” module is designed to allow users to make referrals; the “Sell” module is designed to allow a salesperson to sell premium packages; the “Redeem” module is designed to allow end users to redeem their premiums; the “Fulfill” module is designed to allow fulfillment agents to help end users fulfill their redemption requests. Other modules, or different sets of modules may be part of the central hub 11.

Other Features

Embodiments of the present invention can include many other features, such as: an integrated checks and balances system that gauges, monitors, and reports supply and demand and performance bottlenecks in real time; features that monitor and report abuses (such as when a user might attempt to give consumer-grade premiums to employee end users; or when a group of end users attempt to use a premium restricted to individual travel); features that remotely audit the performance of the system; features that efficiently manage breakage by being able to monitor and quickly alter features of the system; features that judge fax or online submissions to ensure that the submissions are in proper formats; and a naming system that refers to the premiums as “bonds” to denote security and reliability. Some embodiments also include an automated rating system that allows end users and others to rate the performance of the premiums. Preferably, the rating system designates categories by which a premium is rated. Such categories might include customer support, fulfillment technologies and processes, inventory control, audited services, analytics, information design, legal and ethical compliance or performance, and speed and ease of use.

In some embodiments, an independent third party keeps track of and publishes consumer ratings of the premiums. Preferably, this third party issues the premiums and manages the registration and transfer of premiums; the central managing entity takes over from there.

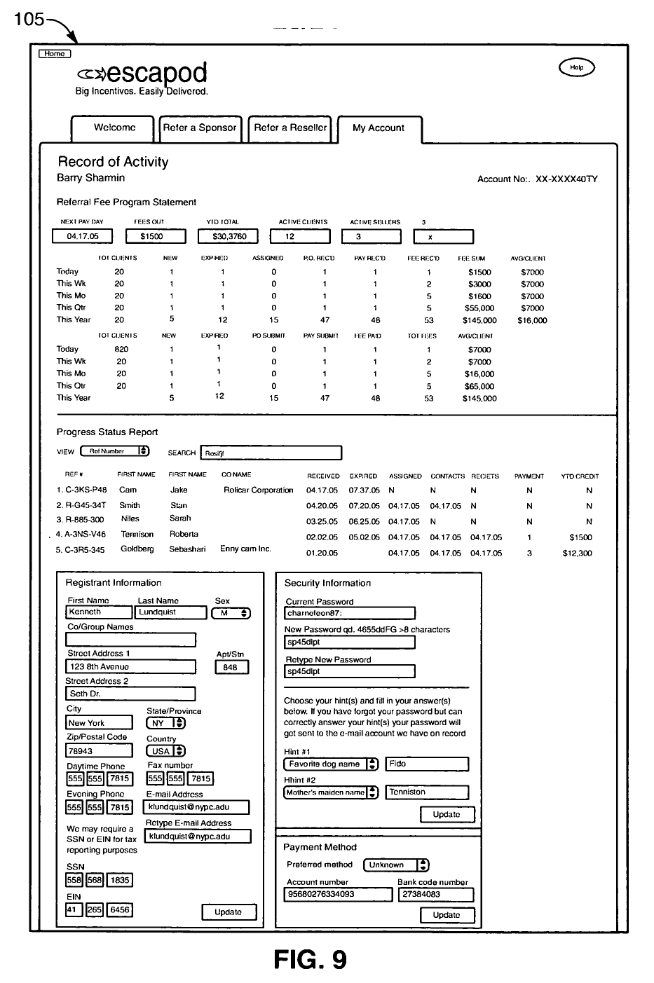

In some embodiments of the present invention, the hub 11 incorporates a referral system that rewards users for successful client referrals. FIG. 9 shows a sample interface 105 that may be used by a salesperson to manage his referral activity.

Some systems of the present invention may also automatically generate real-time progress reports or remind the end user of upcoming expiration dates. The invention may also provide for printable receipts and faxable submissions. The systems and methods of the present invention promote efficiency and scalability by incorporating automated features and built-in elements that are designed to simplify all aspects of the system of premiums.

In summary, the present invention provides unprecedented advantages in a complex industry at risk for profitability and legal reform, and fraught with inefficiencies and lack of trust. The present invention provides embodiments that are modular, scalable, secure, easily customizable, integrated, extensible, and convenient to use. Embodiments of the present invention are usable for simple redemption procedures, but optimal and unique for complex redemption procedures, such as those involving service-or travel-based rewards and expanded option premiums that offer the end user multiple levels of choices.

It should be emphasized that the present invention is not limited to the specific examples described in this Detailed Description. For example, many embodiments have been described in the context of travel premiums, but the present invention encompasses non-travel premiums as well.

It is underscored that the present invention may be embodied in other specific forms without departing from its spirit or essential characteristics. The described embodiments herein should be deemed only as illustrative. Indeed, the appended claims indicate the scope of the invention; the description, being used for illustrative purposes, does not limit the scope of the invention. All variations that come within the meaning and range of equivalency of the claims are to be embraced within their scope.

What is claimed is:

1. A system for managing premiums, the system comprising:
a central management hub having a plurality of modules designed to manage premiums; and
a user interface designed to interact with multiple types of users.

2. The system of claim 1 wherein the user interface is designed to interact with multiple types of users.

3. The system of claim 1 wherein the premiums are transferable between end users.

4. The system of claim 1 further including a premium packaging system.

5. The system of claim 4 wherein the premium packaging system includes tools for relating datasets.

6. The system of claim 1 wherein the user interface is web-based.

7. The system of claim 1 wherein the system further provides for insuring said premiums.

8. The system of claim 1 wherein the premiums are backed by two-factor security.

9. The system of claim 1 wherein the system is monitored by an independent third party.

10. The system of claim 1 wherein the system can monitor and track abuses in real-time.

11. The system of claim 1 wherein a sponsor is provided with private labeling throughout the system.

12. The system of claim 1 wherein the premiums are open-vendor premiums.

13. The system of claim 1 wherein said premiums are expanded option premiums

14. The system of claim 1 wherein said premiums offer service-based rewards.

15. The system of claim 1 wherein said users include vendors, suppliers, salespeople, fulfillment agents, and end users.

16. The system of claim 1 wherein said hub enables automated management of the creation, sales, redemption, and fulfillment of premiums.

17. A computer data signal embodied in a transmission medium such as a carrier wave comprising instructions for:
selling the expanded option premiums;
redeeming the expanded option premiums; and
fulfilling the expanded option premiums.

18. A computer-readable medium comprising instructions for:
creating a plurality of expanded option premiums;
selling the expanded option premiums;
redeeming the expanded option premiums; and
fulfilling the expanded option premiums.

19. An automated, scalable system comprising:
a computer-based central management hub;
means for user access to said hub; and
means for creating, selling, redeeming, and fulfilling a plurality of expanded option premiums.

20. An expanded option premium comprising:
large choice groups;
numerous choice groups; and
disparate choice categories.

21. The premium of claim 20 wherein said premium transforms into an active issue premium from a passive issue premium

22. The premium of claim 20 wherein said premium does not rely on breakage for profitability.

23. The premium of claim 20 wherein said premium is sold at a year-round rate.
